(19) United States
(12) Patent Application Publication
(10) Pub. No.: US 2005/0277101 A1
(43) Pub. Date: Dec. 15, 2005

(54) Method of delivering a test to a candidate

(75) Inventor: Mark Edwin Cadman, North Randwick (AU)

Correspondence Address: VOLENTINE FRANCOS, & WHITT PLLC, ONE FREEDOM SQUARE, 11951 FREEDOM DRIVE SUITE 1260, RESTON, VA, 20190, US

(73) Assignee: Lewis Cadman Consulting PTY LTD., Rosebury (AU)

(21) Appl. No.: 10/528,663

(22) PCT Filed: Sep. 23, 2003
(86) PCT No.: PCT/AU03/01254

§ 371 Date: Jul. 22, 2005

(30) Foreign Application Priority Data
Sep. 23, 2002 (AU) 2002951608

(51) Int. Cl. G09B 3/00

(52) U.S. Cl. 434/350; 434/362; 434/323

(57) ABSTRACT

The invention relates to a method and apparatus for delivering a test, such a test to a candidate. The invention also concerns an apparatus and method of assessing the relative cognitive ability of a candidate. The invention also concerns a method of assessing the progress of a candidate in response to a learning program. The test, assessing or learning program comprise delivering a series of questions type to a candidate, the questions increasing in difficulty as the candidate successfully completes easier questions, the questions being delivered to the candidate in ranges. The questions may be “Swaps” type questions. The candidates may provide their confidence that their answer to any question is correct. A quantifier may be used to assess the candidates progress and/or cognitive skills.

### TECHNICAL FIELD

The invention relates to a method of delivering a test and in particular to a method of delivering a test to a candidate.

The invention has been developed primarily for testing the relative cognitive development of children and will be described hereinafter with reference to that application. It will be appreciated, however, that the invention is not limited to that particular field of use and is also applicable to testing the cognitive abilities of adults, including those who have experienced a loss of cognitive ability due to a physical accident or a mental illness. The invention is also applicable to assessing the progress of a individual with learning difficulties using a learning program.

### BACKGROUND OF THE INVENTION

It has been known to test the cognitive abilities of individuals to gain an indication of the suitability of that individual for a given role in a workplace. This has been applied to recruitment program for businesses and other organisations. It has also been known to apply confidence indicators to these tests to further refine the data provided.

However, the known test is difficult to accurately apply to children and those with learning difficulties. That is, the testing format is unsuitable for individuals of immature cognitive functioning as those individuals are presented with items that are beyond Or memory operating potential. Moreover, the format has no regard for any progressive changes in ability to deal with cognitive complexity that are associated with maturation and with old age. As such, the cult version of the test does not afford a ready way to track cognitive development/degeneration.

Any discussion of the prior art throughout the specification should in no way be considered as an admission that such prior art is widely known or forms part of common general knowledge in the field.

### DISCLOSURE OF THE INVENTION

According to a first aspect of the invention there is provided a method of delivering a test to a candidate, the test having a plurality of questions that are chosen from a plurality of question types ranging from an easiest question type to a hardest question type, the method comprising the sequential stops of:

delivering to the candidate a question selected from the easiest question type and, thereafter, delivering to the candidate one or more questions from the same question type;

delivering to the candidate a question selected from another of the question types and, thereafter, delivering to the candidate one or more questions from the same question type;

wherein at least one question is a “Swaps” question, the “Swaps” question comprising displaying a plurality of images to the candidate in a predetermined spatial relationship and an instruction sequence associated with the images for indicating to the candidate the required reorganisation of the spatial relationship of the images.

The test may include question types 1, 2, . . . , n, where type 1 is the easiest question type and type n is the hardest question type and the method comprises sequentially delivering to the candidate the questions of question type 1, question type 2, . . . and question type n. Optionally, all the questions of a given question type are sequentially delivered to the candidate. The candidate may only be delivered a question when a preceding question in the sequence has been answered.

Optionally, upon answering a question, the candidate is asked to indicate his or her confidence that the answer to the question was correct. The candidate may be asked to indicate his or her confidence that the answer to the question was within one of two or more confidence bands. There may be six confidence bands.

The test may be delivered by a testing device that comprises a display for visually displaying a question to the candidate and an input device for allowing the candidate to answer the question. The testing device may comprise a processor for driving the display and for being responsive to the input device for determining the answer provided by the candidate. Optionally, the input device comprises a keyboard. In other embodiments the input device comprises a pointer device such as a mouse, a track ball or a touch pad. In some embodiments, the input device comprises a combination of the keyboard and the pointer device.

Optionally, the test is contained as question data on a storage medium and the processor selectively accesses the question data to deliver the questions sequentially. The storage medium may also comprise sequence data representative of the sequence in which the question data is accessed by the processor. Even more preferably, the storage medium is controlled by a server that is remote from the processor and which is responsive to predetermined input from the processor for allowing the test to be delivered to the candidate.

In one embodiment, the test is delivered in HTML, while in other embodiments it is delivered as XML. However, in alternative embodiments, the storage medium is a compact disc or other portable storage media that is physically provided to the candidate for interaction with the processor. In other embodiments, the question data and sequence data are provided electronically as an executable file to the processor and/or the candidate.

Optionally, the “Swaps” questions are selected from the above question types, which include:
1. The easiest question type or Level 1—the candidate is instructed to memorise the relative spatial order of the three images and, once the candidate indicates he or she is ready, the test progresses to the next step and requests the candidate to indicate that order from memory. In this Level 1 case there are no swaps per se.
2. Question type 2 or Level 2—the candidate is provided with three images having a predetermined relative spatial order and is instructed to complete a single swap of images. When the candidate indicates that he or she is ready, the test progresses to the next step and requests the candidate to indicate the revised order from memory. For example, the candidate is, in some cases, asked to swap the second and the third image.

3. Question type 3 or Level 3—this is similar to the previous question type, with the exception that the candidate is requested to complete two swaps of the images that have been provided. For example, the instructions in one embodiment are to swap image 2 and image 3, then swap image 1 and image 3. Once the candidate indicates that they are ready, the test progresses to the next step and requests the candidate to indicate the revised order from memory.
4. Question type 4 or Level 4—as with the prior type except that the candidate completes three swaps. In one embodiment the instructions include, for example, to swap image 2 and image 3, then swap image 1 and image 3, and then swap image 1 and image 2.
5. The hardest question type or Level 5—the candidate is instructed to complete four swaps. For example, in one embodiment, the instructions direct that the candidate swap image 2 and image 3, then swap image 1 and image 3, then swap image 1 and image 2, and then swap image 1 and image 3.

Optionally, there may be more question types with the additional question types requiring a larger number of swaps.

The candidate may be provided with a plurality of alternatives from which the answer is selected. However, in other embodiments the candidate clicks and drags the images to the locations that are believed to be correct. Questions of this kind are described in more detail in the earlier filed International Patent Application PCT/AU99/00816, the disclosure of which is incorporated hen by way of cross reference.

Optionally, the time taken for the candidate to read and answer a question is recorded. Optionally, the time taken by the candidate to select a confidence band is also recorded.

According to a second aspect of the invention there is provided an apparatus for delivering a test to a candidate, the test having a plurality of questions that are chosen from a plurality of question types ranging from an easiest question type to a hardest question type, the apparatus comprising:

a display for sequentially displaying to the candidate one or more questions selected from the easiest question type;

input means for allowing the candidate to answer the questions and for triggering the display to display to the candidate the next question in the sequence or, if at the end of the sequence, one or more questions from the next hardest question type;

wherein at least one question is a “Swaps” question, the “Swaps” question comprising a plurality of images displayed in a predetermined spatial relationship and an instruction sequence associated with the images for indicating to the candidate the required reorganisation of the spatial relationship of the images.

According to a third aspect of the invention there is provided a method of assessing the relative cognitive ability of a candidate, the assessment having a plurality of questions that are chosen from a plurality of question types ranging progressively from an easiest question type to a hardest question type, the method comprising the sequential steps of:

delivering to the candidate a question selected from the easiest question type; allowing the candidate to answer the question and, thereafter, delivering to the candidate sequentially one or more questions from the same question type;

determining a quantifier in response to the answers provided by the candidate to the questions of the easiest question type;

if the quantifier is above a predetermined threshold for delivering to the candidate a question selected from another of the question types, delivering to the candidate a question selected from the said another of the question types and, thereafter, delivering to the candidate one or more questions from the same question type; and

deriving an assessment of the relative cognitive ability of a candidate using the quantifier and the question types for which answers have been provided.

Optionally, the said another of the question types is the next in the progressive range of question types.

The method may also comprise determining a second quantifier in response to the answers provided by the candidate to the question of the said another question types. If the second quantifier is above a predetermined second threshold for delivering to the candidate a question selected from the next question type in the progression of question types and, the method may comprise the steps of delivering to the candidate a question selected from the next question type and there after, delivering to the candidate one or more questions from the same question type. That is, the candidate is not presented with a question from a particular question type unless he or she has answered correctly sufficient of the questions in the preceding question types. In some embodiments, the quantifier is determined from the answers of selected ones of the questions of the question type.

According to a fourth aspect of the invention there is provided an apparatus for assessing the relative cognitive ability of a candidate, the assessment having a plurality of questions that are chosen from a plurality of question types ranging progressively from an easiest question type to a hardest question type, the apparatus comprising:

a processor for driving a display to deliver to the candidate a question selected from the easiest question type;

an input device for allowing the candidate to answer the question, wherein the processor is responsive to the answer being provided to subsequently deliver to the candidate sequentially one or more questions from the same question type;

a calculation module being responsive to the answers provided by the candidate to the questions of the easiest question type or determining a quantifier, wherein the processor is responsive to the quantifier being above a predetermined threshold for driving the display to deliver to the candidate a question selected from another of the question types and, thereafter, delivering to the candidate one or more questions from the same question type; and

an assessment module for being responsive to the quantifier and the question types for which answers have been provided for deriving an assessment of the relative cognitive ability of a candidate.

According to a fifth aspect of the invention there is provided a method of assessing the progress of a candidate in response to a learning program, the assessment having a plurality of questions that are chosen from a plurality of question types ranging progressively from an easiest question type to a hardest question type, the method comprising the sequential steps of:

delivering to the candidate a question selected from the easiest question type;

allowing the candidate to answer the question and, thereafter, delivering to the candidate sequentially one or more questions from the same question type in response to the preceding question being answered;

determining a quantifier in response to the answers provided by the candidate to the questions of the easiest question type;

if the quantifier is above a predetermined threshold for delivering to the candidate a question selected from another of the question types, delivering to the candidate a question selected from the said another of the question types and, thereafter, delivering to the candidate one or more questions from the same question type; and

deriving an assessment of the relative cognitive ability of a candidate using the quantifier and the question types for which answers have been provided.

Optionally, at least one question of the third, fourth and fifth aspect of the invention is a “Swaps” question.

In one embodiment, the quantifier is determined upon a weighted sum of any one or more of

correctness of the answers provided by the candidate;

time taken to provide those answers; and

the relationship between the correctness of the answers and confidence indicated by the candidate that his or her answers to the question was correct.

### BRIEF DESCRIPTION OF THE DRAWINGS

Preferred embodiments of the invention will now be described, by way of example only, with reference to the accompanying drawings in which:

FIG. 1 is a schematic view of an apparatus for delivering a test in accordance with the invention; and

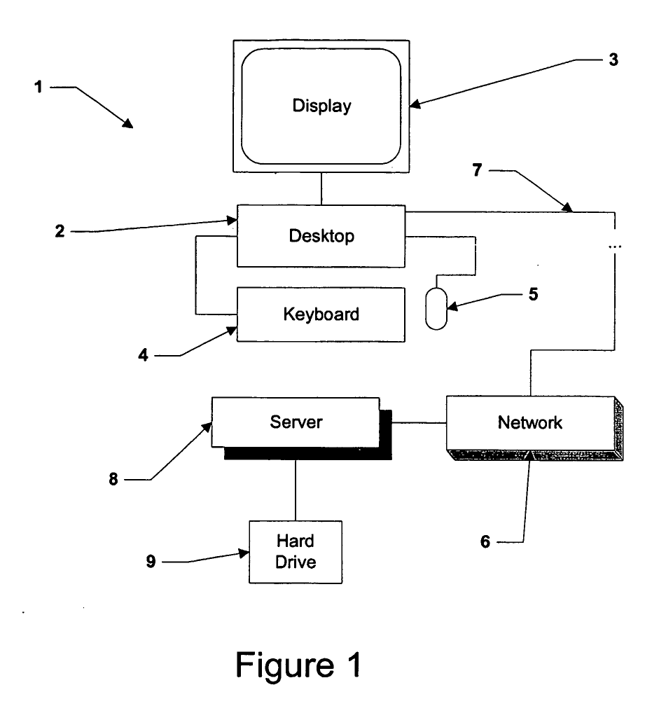

FIG. 2 is a flow chart of a preferred method of using the apparatus of FIG. 1.

### DETAILED DESCRIPTION OF THE DRAWINGS

Referring to the drawings there is illustrated a desktop computer 1 having a desktop unit 2 in which is housed one or more processors, RAM, ROM, hard drives, a network card, other cards and devices and the controlling software. None of these hardware of software components are specifically illustrated and it will be understood by those skilled in the art that many options and combinations of these components are available.

Computer 1 also includes a video display unit (VDU) 3 tat interfaces with unit 2 to display to a candidate selected still and/or video images. An input device, in the form of a keyboard 4 and a mouse 5 allow the candidate to enter data and/or to answer the questions that are presented to them, as will be described in more detail below.

Desktop unit 2 is connected to a network, which in this case is a LAN 6, via a network card (not shown) and cabling 7. The LAN makes use of one of a variety of network protocols and is delivered via a network server (not shown). In some embodiments, the functions of the network server are shared amongst a plurality of interconnected servers.

A test delivery server 8 is connected to LAN 6 and has access to a storage medium in the form of a bard drive 9. This hard drive includes a database of questions that are graded into a plurality of question types ranging from an easiest question type to a hardest question type. The database also includes data indicative of the sequence in which the questions are to be asked and other data for allowing a determination as to whether or not the sequence is to be progressed. This is set out below in more detail.

Initially, the candidate turn computer 1 on and logs into LAN 6 utilising the designated user name and password or passwords. In this case, the candidate is due for an assessment and is provided a prompt by the network that this is so. Preferably, the prompt is in the form of an email including a hypertext link that the candidate is able to click sing mouse 5 so that the first page of the test is delivered. However, in other embodiments, the LAN recognises the user and that an assessment is due and immediately initiates the test.

In this embodiment, the test is delivered in HTML pages that are obtained from hard drive 9 and sequentially delivered to desktop unit 2 via server 8 and LAN 7 and displayed on display 3 to the candidate. In other embodiments, different languages or formats are utilised. In some embodiments the delivery language is XML, although other alternatives are also available.

In other embodiments, use is made of other programming languages. For example, in an “internet” delivered embodiment, the programming is written in the Java language, and the tests as discrete packages or Java Servlets that are transferred to the end-users' computers (the respective candidates' computers) to allow “real time” measurement of reaction time/speed of responding.

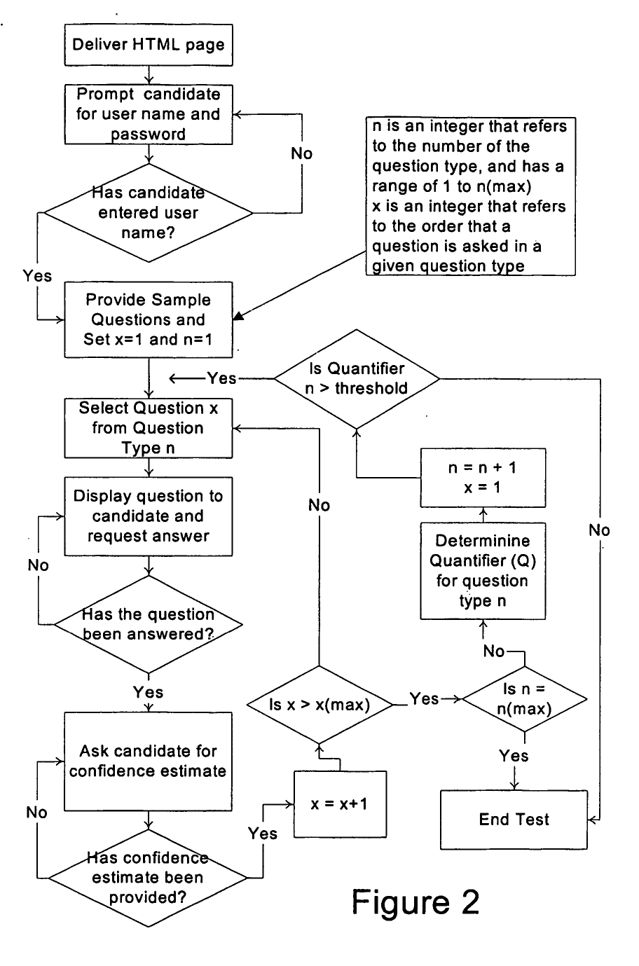

Once the candidate has selected the relevant hypertext link in the email referred to above, the test is commenced and follows the steps set out in graphical form in FIG. 2. The candidate is initially presented with a HTML page that requests confirmation of his or her personal details and the nature of the assessment being conducted. Once this confirmation has been provided, the candidate is delivered a subsequent page that includes an introduction to the test and some instructions as to how the question should be answered. Preferably also, the candidate is provided with the choice of completing one or more sample questions so as to become more familiar with the question format.

Before progressing further through the process of FIG. 2, it is beneficial to look more closely at the format of the test. In this embodiment, the test includes a plurality of questions that are selected from the questions stored on the database. These questions are all categorised with a question type and are designated as question type 1, question type 2, . . . , question type n. Where type 1 is the easiest question type and type n is the hardest question type and the intervening types are graded progressively between the two extremes. That is, as the question type increases, so to does the difficulty of the questions contained within that type.

In the field of cognitive testing, such as that with which the preferred embodiments is concerned, it is known to ask questions that are referred to as “Swaps” questions. This form of question is one of the forms of questions set out in International application no. PCT/AU99/00816 which was filed in the name of the present applicant. The disclosure contained within that application is incorporated herein by way of cross reference.

As used in this embodiment, the “Swaps” questions include a plurality of images, usually three, that are displayed to the candidate in a predetermined spatial relationship. Included under the images is an instruction sequence indicating to the candidate the required spatial reorganisation of those images. This reorganisation is to be performed mentally by the candidate who, once satisfied with the information at hand, has the question removed and is asked to choose, as an answer to the question, one of a plurality of spatial combinations of the images that are presented as being possible answers. The time taken to cognise the question and chose the answer is timed. Moreover, after completing the question, the candidate is asked to quantify his or her confidence that the answer was correct. This quantification is within one of six bands, those being 0% to 17%, 17% to 33%, 33% to 50% 50% to 67%, 67% to 83% and 83% to 100%. In other embodiments a different number of bands are used. In still furher embodimets, the candidate is asked to nominate a percentage confidence. As discussed in the abovementioned PCT patent application, there are embodients where a confidence indication is sought from the candidate after each question is asked, while in other embodiments, that indication is only sought for less than all the questons.

In this embodiment, the images used in the “Swaps” questions are clearly visually distinct. Examples of three images are a house, a car and a bird. Another example is a hammer, a dog and a balloon. As will be appreciated from the teaching herein, many other combinations are possible.

In one enmbodiment, the starting combination of the images is always the same. So, for the examples of the images being that of a house, a car and a bird, the candidate is always provided with the same spatial arrangement of those images with each question. In other embodiments, however, the starting combination is varied throughout the test. That is, even within each question type, the questions will include different combinations of images that are presented to the candidate with the written instructions.

In this embodiment, the starting combination is varied through the test both in the actual images used and the spatial arrangement of those images. While these factors are predetermined for each question, so as to provide equivalence for difference candidates, in other embodiments the determination is random so that different candidates will be presented with different combinations of images.

The test of the preferred embodiment has five question types, which include:
1. The easiest question type or Level 1—the candidate is instructed to memorise the relative spatial order of the three images and, once the candidate indicates he or she is ready, the test progresses to the next step and requests the candidate to indicate that order from memory. In this Level 1 case there are no swaps per se.
2. Question type 2 or Level 2—the candidate is provided with three images having a predetermined relative spatial order and is instructed to complete a single swap of images. When the candidate indicates that he or she is ready, the test progresses to the next step and requests the candidate to indicate the revised order from memory. For example, the candidate is, in some cases, asked to swap the second and the third image. The convention being, that the images are arranged in a linear horizontal array and, progressing from left to right, the images are refereed to as the first, the second and the third images respectively. Alternatively, they are referred to as image 1, image 2 and image 3. In some embodiments, the images are accompanied by a corresponding reference numeral to assist the candidate in understanding this referencing convention.
3. Question type 3 or Level 3—this is similar to the previous question type, with the exception that the candidate is requested to complete two swaps of the images that have been provided. For example, the instructions in one embodiment are to swap image 2 and image 3, then swap image 1 and image 3. Once the candidate indicates that they are ready, the test progresses to the next step and requests the candidate to indicate the revised order from memory.
4. Question type 4 or Level 4—as with the prior type except that the candidate completes three swaps. In one embodiment the instructions include, for example, to swap image 2 and image 3, then swap image 1 and image 3, and then swap image 1 and image 2.
5. The hardest question type or Level 5—the candidate is instructed to complete four swaps. For example, in one embodiment, the instructions direct that the candidate swap image 2 and image 3, then swap image 1 and image 3, then swap image 1 and image 2, and then swap image 1 and image 3.

Optionally, there may be more question types with the additional question types requiring a larger number of swaps.

Once the candidate bas reviewed the images and the associated instructions concerning the swaps that are to be cognised, he or she uses mouse 5 to activate a hypertext link that delivers to the candidate a plurality of alternatives from which the answer is to be selected. That is, the questions are in the form of multiple-choice questions. Importantly, the candidate is not now able to access both the question and the initial spatial arrangement of images upon which the question is based. This requires the candidate to retain information, in the short term, of the spatial order of the “swapped” images. In the case of web delivered test this is achieved by disabling the history function and “Back” button of the web browser. In other embodiments alternative means are relied upon.

In other embodiments, once the candidate indicates that he or she has read the required instructions, the next page is delivered, but this does not present the candidate with a choice of answer. Rather, the candidate is presented with the images in the original relationship and required to use the mouse to sequentially designate which of the images is in the left most, the middle and the right most positions. For non-web-based delivery making use of this mode of answer, the user is required to “click and drag” the images—which are present in the initial spatial relationship—to the locations that are believed to accord with that directed by the instructions.

The time taken for the candidate to read and answer a question is recorded. More preferably, the time taken by the candidate to select a confidence band is also recorded. The first is used to provide an indication of the level of candidate's confidence that he or she correctly answered the questions concerned, while the second provides an indication of the general confidence of the candidate.

Referring to FIG. 2, once the user has entered his or her details, server 8 is provided with that information and configures the test to be delivered, in the event that that is required for that candidate. For example, in some embodiments the candidate is attempted one in a series of tests to provide an ongoing assessment of both the candidate's cognitive abilities and any progress or improvement that is being made in response to a learning program that the candidate is being subjected to. In this case, server 8 is responsive to the identity information provided by the candidate to prepare to deliver the desired test in the series of test being undertaken. That is, the test regime is not only responsive to the candidate, but also the results of earlier tests taken by the candidate and the results of those test.

Once server 8 has configured the test and the proposed questions to be presented to the candidate, those questions are arranged in groups of question types such as the Level 1, Level 2, Level 3, Level 4 and Level 5 question types referred to above. Each of these question types includes usually five or more questions of that type. That is, a typical test includes twenty five questions in total. However, in other embodiments it more or less questions of each question type are used. Moreover, in further embodiments, there are not necessarily the same number of questions in each question type.

While the accuracy of the test will be theoretically improved with the greater number of questions asked, there is a practical trade off due to the attention span and concentration levels that are able to be provided by the candidate. For young children and candidates with learning disabilities, relatively few questions are used, while for adults it is possible to gain more accuracy through the use of a greater number of questions.

Server 8 also designates each question in a given question type with a reference that determines the order that the question will be presented to the candidate. For example, in this embodiment, the Level 1 question type includes four “Swaps” questions, which are reference as 1, 2, 3 and 4 respectively. This reference corresponds to the variable “x” in FIG. 2, while the question type corresponds to the variable “n”.

Initially, both x and n are set to 1, and are incremented by 1 in accordance with the flow chart of FIG. 2. As will be apparent to a skilled addressee, from the teaching herein, x and n are integers, where 1≦x≦x₍ₘₐₓ₎ and 1≦n≦n₍ₘₐₓ₎. In this embodiment, x₍ₘₐₓ₎=4 for the question type referred to as Level 1, while n₍ₘₐₓ₎=5, in that there are five question types. In other embodiments both x₍ₘₐₓ₎ and n₍ₘₐₓ₎ have other values.

Server 8 presents the candidate with question 1 of the Level 1 question type. Once the candidate is satisfied with the question, use is made of the mouse to indicate that this is the case. For example for the web-delivered test of the present embodiment, the candidate provided that indication by manoeuvring mouse 5 so that the cursor displayed on VDU 3 overlies a clearly labelled “Proceed” button on the web page. One of the buttons on mouse 5 is depressed by the candidate to click the “Proceed” button. Server 8 delivers a subsequent web page providing the choices from which the candidate must select the answer to the question. Again, use is made of mouse 5 to click on the selected choice. Server 8 is responsive to the click to not only gather the relevant information as to the answer provided and the time taken by the candidate, but also to deliver a subsequent page requesting a confidence indicator from the candidate. In this embodiment, there are six confidence bands that are graphically represented on VDU 3. The candidate selects one of the bands through use of mouse 5.

With the fist question being answered and a confidence indicator obtained, server 8 increments x by 1 and determines whether the new value for x exceeds x₍ₘₐₓ₎.

If not, the test progresses to ask the next question in that same question type. This loop —referred to as the first loop—is continued until x=x₍ₘₐₓ₎. That is, all the questions of the easiest question type are presented, and answers obtained, prior to any other questions of a different—and in this case more challenging—question type are presented.

The test also includes a “time out” provision, in that if the candidate does not answer the question within a predetermined period, the test will signal that the time available to answer the question has lapsed. Server 8 is made aware of the time out increments x by 1, and then proceeds with the steps that would have otherwise been followed.

If, once incremented, x>x₍ₘₐₓ₎ then there are no further questions of that question type to be presented to the candidate for this particular assessment. That being the case, the test branches from the first loop into a second loop. This second loop includes the first step of determining whether n=n₍ₘₐₓ₎. If yes, then the test is complete and the candidate is informed accordingly. If no, server 8 determines a quantifier for the question type. This quantifier is referred to as Qₙ. For this embodiment there will be a maximum of four quantifiers calculated, Q₁, Q₂, Q₃, and Q₄. A quantifier is not required for the Level 5 question type, as will be explained below. However, in some embodiments Q₅ is calculated for use in subsequent assessments undertaken by the candidate.

In this embodiment the quantifier is calculated by server 8 based upon a weighted sum of: the correctness of the answers provided by the candidate; the time taken to provide those answers; and the relationship between the correctness of the answers and the confidence indicators. In other embodiments, the quantifier is calculated in response to less factors or, in further embodiment, other factors. If the quantifier does not exceed the threshold, the test ends.

If the quantifier, once calculated for a given question type, exceeds a predetermined threshold for that question type, n is incremented by 1 and x is set to 0. That is, server 8 progresses to the next question type, as all the question of the Preceding type have already been presented. The process then returns to the first loop until all the questions of the new question type are presented and answered. When this has occurred, the process returns to the second loop. When all the questions to be presented have been presented, the test ends by branching to the “End Test” box.

As referred to above, the question types are presented in order of difficulty. Accordingly, a candidate is only required to answer the more difficult questions only once he or she has demonstrated that the easier questions are able to be sufficiently cognised and correctly answered. Moreover, the threshold for the quantifiers changes, in this embodiment, for the different question types and the candidate. That is, for the higher level question types, the quantifier is lower, as more time is allowed for the candidate to answer these questions.

In other embodiments it is known to use more or less than five levels of questions. In practice, however, it has been found that five levels is a good balance, particularly for younger candidates.

In other embodiments the confidence of the candidate may be captured in a different way, such as typing in the specific percentage or any other method that enables the information to be captured.

All embodiments, regardless of the number of question levels, present those questions in a systematic and structured order, progressing from the easiest type to the hardest type. This allows the candidate to only have to answer as many questions as are relevant, and not have to be unnecessarily preoccupied with answering questions that are simply beyond their cognitive ability at that time. The nature of the test also allows it to be regularly reused, particularly in cases where a candidate does not progress through all the available levels of questions.

In the embodiment described above, the test automatically advances and concludes in accordance with the answers provided by the candidate. In other embodiments, however, the administrator of the test has the ability to intervene and progress the test or conclude the test, notwithstanding that this would not have occurred otherwise. That is, the administrator is provided with real time access to the test results so that in situ control by the administrator is allowed.

The preferred embodiment of the invention includes the following advantages:
1. It is applicable to a wide range of age groups as the complexity of the test changes between levels. That is, test takers range from very young children to senior age adults.
2. It is used to determine a level of cognitive functioning (by determining the complexity the test taker effectively deals with) in comparison to test takers of their own broad age group. As such, delays in functioning, or functioning over and above expected levels, are more readily mapped through a single test.
3. Improvements/deterioration in cognitive functioning are readily determined over time.

Applications of the preferred embodiments include:
1. Assessing the cognitive development of children;
2. Assessing the progress of an injured adult in a cognitive rehabilitation program.
3. Assessing the cognitive effects of a pharmaceutical on a candidate.
4. Assessing the cognitive effects of aging and disease.

The embodiment described in detail above utilises an input device in the form of a desk top computer having a VDU, a mouse and a keyboard, amongst other things. In some embodiments, however, use is made of a touch screen. In other embodiments, use is made of voice recognition software and the associated microphones to allow the users to input their respective responses to the questions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of delivering a test to a candidate, the test having a plurality of questions that are chosen from a plurality of question types ranging from an easiest question type to a hardest question type, the method comprising the sequential steps of:
delivering to the candidate a question selected from the easiest question type and, thereafter, delivering to the candidate one or more questions from the same question type;
delivering to the candidate a question selected from another of the question types and, thereafter, delivering to the candidate one or more questions from the same question type;
wherein at least one question is a “Swaps” question, the “Swaps” question comprising displaying a plurality of images to the candidate in a predetermined spatial relationship and an instruction sequence associated with the images for indicating to the candidate a required reorganisation of the spatial relationship of the images.

2. A method of delivering a test to a candidate according to claim 1, wherein the test comprises question types 1, 2, . . . , n, where type 1 is the easiest question type and type n is the hardest question type, and the method comprises sequentially delivering all the questions of a given question type to the candidate and sequentially delivering to the candidate the question types in the order of question type 1 to question type n.

3. A method of delivering a test to a candidate according to claim 2, wherein the candidate is only delivered a question when a preceding question in the sequential delivery has been answered.

4. A method of delivering a test to a candidate according to claim 1, wherein upon answering a question, the method further comprises asking the candidate to indicate his or her confidence that the answer to the question was correct.

5. A method of delivering a test to a candidate according to claim 4, wherein the candidate is asked to indicate his or her confidence that the answer to the question was within one of two or more confidence bands.

6. A method of delivering a test to a candidate according to claim 1, wherein the test is delivered by a testing device that comprises a display for visually displaying a question to the candidate, an input device for allowing the candidate to answer the question and a processor for driving the display and for being responsive to the input device for determining the answer provided by the candidate.

7. A method of delivering a test to a candidate according to claim 6, wherein the test is contained as question data on a storage medium and the processor selectively accesses the question data to deliver the questions sequentially.

8. A method of delivering a test to a candidate according to claim 7, wherein the storage medium comprises sequence data representative of the sequence in which the question data is accessed by the processor.

9. A method of delivering a test to a candidate according to claim 7, wherein the storage medium is controlled by a server that is remote from the processor and which is responsive to predetermined input from the processor for allowing the test to be delivered to the candidate.

10. A method of delivering a test to a candidate according to claim 1, wherein the method further comprises recording the time taken for the candidate to read and answer a question.

11. A method of delivering a test to a candidate according to claim 4, wherein the method further comprises recording the time taken by the candidate to indicate their confidence.

12. A method of delivering a test to a candidate according to any one of the preceding claims, wherein the method further comprises the step of assessing the relative cognitive ability of the candidate based upon a consideration of any one or more of:
correctness of some or all of the answers provided by the candidate;
time taken to provide those answers; and
the relationship between the correctness of some or all the answers and confidence indicated by the candidate that his or her answers to the question questions were correct.

13. An apparatus for delivering a test to a candidate, the test having a plurality of questions that are chosen from a plurality of question types ranging from an easiest question type to a hardest question type, the apparatus comprising:
a display for sequentially displaying to the candidate one or more questions selected from the easiest question type;
input means for allowing the candidate to answer the questions and for triggering the display to display to the candidate the next question in the sequence or, if at the end of the sequence, one or more questions from the next hardest question type;
wherein at least one question is a “Swaps” question, the “Swaps” question comprising a plurality of images displayed in a predetermined spatial relationship and an instruction sequence associated with the images for indicating to the candidate a required reorganisation of the spatial relationship of the images.

14. An apparatus for delivering a test to a candidate according to claim 13, wherein the input means allows the candidate to indicate his or her confidence that the answer to the question was correct.

15. An apparatus for delivering a test to a candidate according to claim 14, wherein the input means allows the candidate to indicate his or her confidence that the answer to the question was within one of two or more confidence bands.

16. An apparatus for delivering a test to a candidate according to claim 13, further comprising:
a storage medium on which the test is stored as question data; and
a processor adapted to selectively access the question data to deliver the questions sequentially.

17. An apparatus for delivering a test to a candidate according to claim 16, wherein the storage medium comprises sequence data representative of the sequence in which the question data is accessed by the processor.

18. An apparatus for delivering a test to a candidate according to claim 16, wherein the storage medium is controlled by a server that is remote from the processor and which is responsive to predetermined input from the processor for allowing the test to be delivered to the candidate.

19. An apparatus for delivering a test to a candidate according to claim 13, further comprising timing means to record the time taken for the candidate to read and answer a question.

20. An apparatus for delivering a test to a candidate according to claim 13, further comprising a processor for assessing the relative cognitive ability of the candidate based upon a consideration of any one or more of:
correctness of some or all of the answers provided by the candidate;
time taken to provide those answers; and
the relationship between the correctness of some or all the answers and confidence indicated by the candidate that his or her answers to the questions were correct.

21. A method of assessing the relative cognitive ability of a candidate, the assessment having a plurality of questions that are chosen from a plurality of question types ranging progressively from an easiest question type to a hardest question type, the method comprising the sequential steps of:
delivering to the candidate a question selected from the easiest question type;
allowing the candidate to answer the question and, thereafter, delivering to the candidate sequentially one or more questions from the same question type;
determining a quantifier in response to the answers provided by the candidate to the questions of the easiest question type;
if the quantifier is above a predetermined threshold for delivering to the candidate a question selected from another one of the question types, delivering to the candidate a question selected from the other one of the question types and, thereafter, delivering to the candidate one or more questions from the same other one of the question types; and
deriving an assessment of the relative cognitive ability of a candidate using the quantifier and the question types for which answers have been provided.

22. A method of assessing the relative cognitive ability of a candidate according to claim 21, wherein the other one of the question types is the next question type in the progressive range of question types.

23. A method of assessing the relative cognitive ability of a candidate according to claim 21, wherein the method comprises determining a second quantifier in response to the answers provided by the candidate to the questions of the other one of the question types.

24. A method of assessing the relative cognitive ability of a candidate according to claim 23, wherein if the second quantifier is above a predetermined second threshold for delivering to the candidate a question selected from the next question type in the progression of question types, the method further comprises the steps of delivering to the candidate a question selected from the next question type and thereafter, delivering to the candidate one or more questions from the same next question type.

25. A method for assessing the relative cognitive ability of a candidate according to claim 21, wherein at least one question is a “Swaps” question, the “Swaps” question comprising a plurality of images displayed in a predetermined spatial relationship and an instruction sequence associated with the images for indicating to the candidate a required reorganisation of the spatial relationship of the images.

26. A method according to claim 21, wherein the quantifier is determined upon a consideration of any one or more of:
correctness of some or all of the answers provided by the candidate;
time taken to provide those answers; and
the relationship between the correctness of some or all the answers and confidence indicated by the candidate that his or her answers to the questions were correct.

27. An apparatus for assessing the relative cognitive ability of a candidate, the assessment having a plurality of questions that are chosen from a plurality of question types ranging progressively from an easiest question type to a hardest question type, the apparatus comprising:
a processor for driving a display to deliver to the candidate a question selected from the easiest question type;
an input device for allowing the candidate to answer the question, wherein the processor is responsive to the answer being provided to subsequently deliver to the candidate sequentially one or more questions from the same question type;
a calculation module being responsive to the answers provided by the candidate to the questions of the easiest question type for determining a quantifier, wherein the processor is responsive to the quantifier being above a predetermined threshold for driving the display to deliver to the candidate a question selected from another one of the question types and, thereafter, delivering to the candidate one or more questions from the other one of the question types; and
an assessment module responsive to the quantifier and the question types for which answers have been provided to derive an assessment of the relative cognitive ability of a candidate.

28. An apparatus for assessing the relative cognitive ability of a candidate according to claim 27, wherein the other one of the question types is the next question type in the progressive range of question types.

29. An apparatus for assessing the relative cognitive ability of a candidate according to claim 27, wherein the calculation module further determines a second quantifier in response to the answers provided by the candidate to the questions of the other one of the question types.

30. An apparatus for assessing the relative cognitive ability of a candidate according to claim 29, wherein the processor is also responsive to the second quantifier being above a predetermined second threshold for driving the display to deliver to the candidate a question selected from the next question type in the progression of question types, and thereafter, delivering to the candidate one or more questions from the same next question type.

31. An apparatus for assessing the relative cognitive ability of a candidate according to claim 27, wherein the calculation module determines the quantifier based upon any one or more of:
correctness of some or all of the answers provided by the candidate;
time taken to provide those answers; and
the relationship between the correctness of some or all the answers and confidence indicated by the candidate that his or her answers to the questions were correct.

32. An apparatus for assessing the relative cognitive ability of a candidate according to claim 27, wherein at least one question is a “Swaps” question, the “Swaps” question comprising a plurality of images displayed in a predetermined spatial relationship and an instruction sequence associated with the images for indicating to the candidate a required reorganisation of the spatial relationship of the images.

33. A method of assessing progress of a candidate in response to a learning program, the assessment having a plurality of questions that are chosen from a plurality of question types ranging progressively from an easiest question type to a hardest question type, the method comprising the sequential steps of:
delivering to the candidate a question selected from the easiest question type;
allowing the candidate to answer the question and, thereafter, delivering to the candidate sequentially one or more questions from the same question type in response to the preceding question being answered;
determining a quantifier in response to the answers provided by the candidate to the questions of the easiest question type;
if the quantifier is above a predetermined threshold for delivering to the candidate a question selected from another one of the question types, delivering to the candidate a question selected from the other one of the question types and, thereafter, delivering to the candidate one or more questions from the other one of the question types; and
deriving an assessment of the relative cognitive ability of a candidate using the quantifier and the question types for which answers have been provided.

34. A method of assessing progress of a candidate in response to a learning program according to claim 33, wherein the quantifier is determined upon a consideration of any one or more of:
correctness of some or all of the answers provided by the candidate;
time taken to provide those answers; and
the relationship between the correctness of some or all the answers and confidence indicated by the candidate that his or her answers to the questions were correct.

35. A method of assessing progress of a candidate in response to a learning program of according to claim 33, wherein at least one question is a “Swaps” question, the “Swaps” question comprising displaying a plurality of images to the candidate in a spatial relationship and an instruction sequence associated with the images for indicating to the candidate a required reorganisation of the spatial relationship of the images.

36. A method according to claim 1, wherein the “Swaps” question has three images that are clearly visually distinct.

37. A method according to claim 1, wherein to answer the “Swaps” question, the candidate clicks and drags the images to the spatial locations that are believed to be correct.

38. A method according to claim 1, wherein a plurality of alternative answers to the “Swaps” question is displayed to the candidate, and the candidate selects one of the alternatives.

39. A method according to claim 1, wherein all the questions are “Swaps” questions and the instruction sequence of each question in a particular question type includes the same number of swap instructions requiring the spatial reorganisation of two images.

40. A method of delivering a test to a candidate according to claim 39, wherein the harder the question type, the larger the number of swaps instructions are included in the instruction sequence.

41. An apparatus for delivering a test to a candidate according to claim 13, wherein all the questions are “Swaps” questions and the instruction sequence of each question in a particular question type includes the same number of swap instructions requiring the spatial reorganisation of two images.

42. A method of delivering a test to a candidate according to claim 41 wherein the harder the question type, the larger the number of swaps instructions are included in the instruction sequence.

43. A method for assessing the relative cognitive ability of a candidate according to claim 25, wherein all the questions are “Swaps” questions and the instruction sequence of each question in a particular question type includes the same number of swap instructions requiring the spatial reorganisation of two images.

44. A method of delivering a test to a candidate according to claim 43, wherein the harder the question type, the larger the number of swaps instructions are included in the instruction sequence.

45. An apparatus for assessing the relative cognitive ability of a candidate according to claim 32, wherein all the questions are “Swaps” questions and the instruction sequence of each question in a particular question type includes the same number of swap instructions requiring the spatial reorganisation of two images.

46. A method of delivering a test to a candidate according to claim 45, wherein the harder the question type, the larger the number of swaps instructions are included in the instruction sequence.

47. A method for assessing the progress of the candidate in response to a learning program according to claim 35, wherein all the questions are “Swaps” questions and the instruction sequence of each question in a particular question type includes the same number of swap instructions requiring the spatial reorganisation of two images.

48. A method of delivering a test to a candidate according to claim 47, wherein the harder the question type, the larger the number of swaps instructions are included in the instruction sequence.
